(19) United States
(12) Patent Application Publication
(10) Pub. No.: US 2015/0042223 A1
(43) Pub. Date: Feb. 12, 2015

(54) INDUCTIVELY COUPLED LED LIGHTING SYSTEM

(71) Applicant: Daniel P. Harrington, Boise, ID (US)

(72) Inventor: Daniel P. Harrington, Boise, ID (US)

(21) Appl. No.: 14/457,331

(22) Filed: Aug. 12, 2014

Related U.S. Application Data
(60) Provisional application No. 61/865,047, filed on Aug. 12, 2013.

(51) Int. Cl. H05B 33/08; F21V 23/02; B63B 45/00; F21V 31/00

(52) U.S. Cl. CPC H05B 33/0809; F21V 31/00; F21V 23/026; B63B 45/00; B63B 2045/005
USPC 315/70

(57) ABSTRACT

An inductively coupled LED lighting system including an LED light module mountable on one side of a surface of a partition and a power module mountable on an opposing surface. The LED light module and the power module are aligned to allow for an inductive transfer of power. The LED light module includes a first coil connected to one or more LEDs. The LED light module also includes a base, a lens fixed to the base enclosing the circuitry in an enclosure and attachment means for attaching the LED light module to a surface. An alternating current or a direct current power source is connected to the power module. Alternating current or pulsed direct current is directed through a connected first coil creating a fluctuating inductive field. Electromagnetic power produced in the power module coil is inductively transferred to the coil in the LED light module powering the LEDs.

This application claims the benefit of U.S. Provisional Application No. 61/865,047, entitled Inductively Coupled LED Lighting System, filed Aug. 12, 2013.

### BACKGROUND OF THE INVENTION

1. Field of the Invention

The present invention relates generally to lighting and more particularly to an inductively coupled LED lighting system that allows for a no-hole or holeless mounting of LED lighting to a surface, for instance the hull of a water craft.

2. Background

Lighting, for example lighting for the exterior of a watercraft has always required that a light fixture be affixed to the hull of the craft and a hole formed through the hull to connect the light fixture to the boats power source or supply.

Advantage may therefore be found in providing a lighting system that allows for lighting to be fixed to surface of a watercraft that is exposed to water without forming holes to provide power to the light fixture mounted for instance to the exterior surface of the hull or cockpit of the watercraft.

SUMMARY OF THE INVENTION

An inductively coupled light emitting diode, (LED), lighting system including an LED light module that may be mounted on one side of a surface of a non-metallic barrier, for example fiberglass hull of a boat, a wooden partition or the like, and a power module that is mountable on an opposing surface of the partition or barrier, the LED light module and the power module aligned to allow for an inductive transfer of power.

The inductively coupled LED lighting system comprises two modules, the LED light module and the power module. The LED light module includes a coil of wire connected to one or more LEDs. In a preferred embodiment the LED light module also includes a base to which the circuitry is mounted, a lens fixed to the base enclosing the circuitry in a watertight enclosure and attachment means for attaching the LED light module to a surface. The attachment means may include adhesive connectors, mechanical connectors or other known means for attaching the modules to a surface. The power module provides an AC or pulsed DC power source through a coil of wire creating a fluctuating inductive field. The AC or pulsed DC current can be generated with internal circuitry or using an AC power source. The power module provides a fluctuating current determined by the circuit for DC power source or AC power source directly. The changes in current through the coil induce rising and falling inductive fields. In one embodiment, the power module is configured as a circuit that converts 12V DC to an AC signal which is conducted through a wire coil assembly. The intensity of the LEDs can be varied by the coil configuration of both modules and power applied to the power module. In a preferred embodiment the power module also includes a base to which the circuitry is mounted, a housing fixed to the base and enclosing the circuitry and attachment means for attaching the power module to a surface.

The LED light module and the power module are mountable on opposite sides of a barrier, aligned one to the other so that electromagnetic power produced in the power module coil is inductively transferred to the coil in the LED light module powering the LEDs. The electromagnetic transfer or inductive powering of the LEDs in the LED light module can be accomplished with many variations of coil and current designs for efficiency gains but overall is not really part of the intent. Any current pulsating through a wire or coils of wire will produce electromagnetic power transfer.

The inductively coupled LED lighting system of the present invention also includes circuitry for conditioning current from a power source to provide a pulsed current.

Advantage is also found in the inductively coupled LED lighting system of the present invention by way of the fact that no holes need to be drilled for providing power to a lighting unit mounted to the exterior surface of the hull or cockpit of a watercraft. In one embodiment, a marine light is designed to allow a no-hole or holeless mounting of LED lighting to the hull of a water craft. The LED light module is attached to the outside surface of the hull, preferably by an adhesive and the power module is aligned with the LED light module and attached to an inside surface of the hull. Because no physical external connection is required between the power module and the LED light module, the LED light module can be completely sealed for underwater or weather exposed use.

Advantage is also found in the inductively coupled LED lighting system of the present invention by way of the fact that lighting can be moved changed or replaced with little to no damage to the surfaces to which the modules are attached.

The foregoing description of the illustrated embodiments has been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Elements described might be interchangeable with other elements in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . . ”

### DESCRIPTION OF THE DRAWING

FIG. 1 is a representative side cutaway view of an inductively coupled LED lighting system according to the present invention.

### DETAILED DESCRIPTION OF THE INVENTION

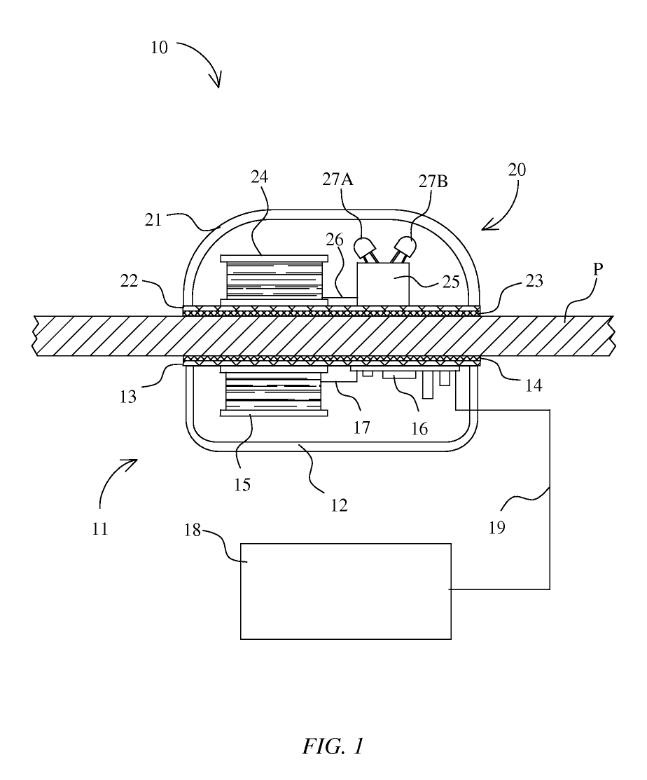

Referring to FIG. 1, inductively coupled LED lighting system 10 is shown including and power module 11 and LED light module 20. Power module 11 includes power module housing 12 attached to power module base 13. Power module 11 is shown attached to partition P using adhesive connector 14. First coil 15 is housed within power module housing 12 and is conductively connected power conditioning circuit 16 by conductor 17. Power source 18 is conductively connected to power conditioning circuit 16 by conductor 19.

With continued reference to FIG. 1, LED light module 20 includes light module housing 21 attached to light module base 22. In one preferred embodiment of the invention, light module housing 21 and light module base 22 form a watertight enclosure. Light module housing 21 is formed as a transparent lens. LED light module 20 is shown attached to partition P just opposite power module 11 using adhesive connector 23 for instance a silicon sealant. Second coil 24 is housed within light module housing 21 and is conductively connected to circuit board 25 by conductor 26. LEDs 27A and 27B are shown conductively connected to circuit board 25. In one embodiment of the invention, light module housing 21, or a portion of light module housing 21 may include a fractal surface adapted to scatter and distribute light emitted by LEDs 27A and 27B.

When LED light module 20 is positioned proximate to power module 11, and the circuitry is energized, second coil 24 is inductively coupled to first coil 15. LEDs 27A and 27B conductively connected to second coil 24 are energized by the fluctuating inductive field of first coil 15.

Power source 18 may comprise a direct current source for instance a battery as found in vehicles and many water craft. In this case power conditioning circuit 16 includes circuitry adapted to provide a pulsed output to first coil 15. In the alternative, power source 18 may comprise an alternating current source for instance common 120 volt or current provided by an external power inverter, conductively connected to power conditioning circuit 16 that provides a pulsed output to first coil 15.

In one preferred embodiment of the invention, partition P comprises the hull or other surface of a watercraft, wherein the environment on a first side of partition P, the side to which power module 11 is affixed is characterized generally as a dry environment and a second side of partition P, the side to which LED light module 20 is affixed is characterized generally as an aquatic environment exposed repeatedly to water and environmental elements.

What is claimed is:

1. An inductively coupled LED lighting system comprising:
a direct current power source;
a power conditioning circuit conductively connected to the direct current power source, the power conditioning circuit adapted to provide a pulsed DC current;
a first coil conductively connected to the power conditioning circuit, the first coil adapted to produce a fluctuating inductive field; and
an LED light module including a second coil inductively couplable to the first coil when the LED light module is positioned proximate to the power module, the second coil conductively connected to one or more LEDs, the one or more LEDs energizeable by the fluctuating inductive field produced by the first coil.

2. The inductively coupled LED lighting system of claim 1 wherein the LED light module further comprises a base, a lens fixed to the base enclosing the second coil and the one or more LEDs, the LED light module further comprising attachment means for attaching the LED light module to a surface.

3. The inductively coupled LED lighting system of claim 1 wherein the power module further comprises a housing adapted to enclose the first coil, the power module further comprising attachment means for attaching the power module to a surface.

4. The inductively coupled LED lighting system of claim 1 wherein the LED light module further comprises a housing including a base and a lens fixed to the base enclosing the second coil and the one or more LEDs, the LED light module further comprising attachment means the LED light module to a surface.

5. The inductively coupled LED lighting system of claim 1 wherein the LED light module further comprises a watertight housing including a base and a lens fixed to the base enclosing the second coil and the one or more LEDs, the LED light module further comprising attachment means the LED light module to a surface.

6. The inductively coupled LED lighting system claim 1 further comprising a power conditioning circuit, the power conditioning circuit adapted to control an output intensity of the LEDs.

7. An inductively coupled LED lighting system comprising:
an alternating current power source;
a power module conductively connected to the alternating current power source, the power module including a first coil adapted to produce a fluctuating inductive field; and
an LED light module including a second coil inductively couplable to the first coil when the LED light module is positioned proximate to the power module, the second coil conductively connected to one or more LEDs, the one or more LEDs energizeable by the fluctuating inductive field produced by the first coil.

8. The inductively coupled LED lighting system of claim 7 wherein the LED light module further comprises a base, a lens fixed to the base enclosing the second coil and the one or more LEDs, the LED light module further comprising attachment means for attaching the LED light module to a surface.

9. The inductively coupled LED lighting system of claim 7 wherein the power module further comprises a housing adapted to enclose the first coil, the power module further comprising attachment means for attaching the power module to a surface.

10. The inductively coupled LED lighting system of claim 7 wherein the LED light module further comprises a housing including a base and a lens fixed to the base enclosing the second coil and the one or more LEDs, the LED light module further comprising attachment means the LED light module to a surface.

11. The inductively coupled LED lighting system of claim 7 wherein the LED light module further comprises a watertight housing including a base and a lens fixed to the base enclosing the second coil and the one or more LEDs, the LED light module further comprising attachment means the LED light module to a surface.

12. The inductively coupled LED lighting system claim 7 wherein an intensity of the LEDs can be varied by the coil configuration of either the power module or the LED light module.

13. The inductively coupled LED lighting system claim 7 further comprising a power conditioning circuit, the power conditioning circuit adapted to control an output intensity of the LEDs.

14. An inductively coupled LED lighting system adapted to provide marker lighting for watercraft, the inductively coupled LED lighting system comprising:
a direct current power source;
a power module including a housing adapted to enclose a first coil, the power module further comprising attachment means for attaching the power module to an interior surface of a watercraft surface;
a power conditioning circuit conductively connected to the power source, the power conditioning circuit adapted to provide a pulsed current;
a first coil conductively connected to power conditioning circuit, the first coil adapted to produce a fluctuating inductive field; and
an LED light module including a watertight housing adapted to enclose a second coil and one or more LEDs conductively connected to the second coil, the LED light module further comprising a lens, the LED light module further comprising attachment means for attaching the LED light module to an exterior surface of the watercraft surface opposite the power module, the second coil inductively couplable to the first coil when the LED light module is positioned proximate to the power module, the one or more LEDs energizeable by the fluctuating inductive field produced by the first coil.

15. The inductively coupled LED lighting system of claim 14 further comprising:
the power source configured as a direct current power source; and
a power conditioning circuit conductively connected to the direct current power source, the power conditioning circuit adapted to provide a pulsed DC current.
